(19) United States
(12) Patent Application Publication
(10) Pub. No.: US 2015/0153056 A1
(43) Pub. Date: Jun. 4, 2015

(54) METHODS FOR OPERATING HEATING, VENTILATION AND AIR CONDITIONING SYSTEMS

(71) Applicant: INTELLINOX INC., Quebec (CA)

(72) Inventors: Marc Gretillat, Quebec (CA); Alexandre Rousseau, Quebec (CA); Philippe E.J. Bernard, Quebec (CA); Mario Rousseau, Quebec (CA)

(21) Appl. No.: 14/406,122

(22) PCT Filed: Jun. 7, 2013
(86) PCT No.: PCT/CA2013/050437

§ 371 Date: Dec. 5, 2014

Related U.S. Application Data
(60) Provisional application No. 61/656,767, filed on Jun. 7, 2012.

(51) Int. Cl. F24F 11/00; G05B 15/02

(52) U.S. Cl. CPC F24F 11/006; G05B 15/02

(57) ABSTRACT

A control method is for controlling a variable-speed direct gas-fired air-handling unit of a heating, ventilation and air conditioning system. The method includes sensing a make-up temperature of the system and comparing the sensed make-up air temperature to a make-up air temperature setpoint. If the sensed make-up air temperature is above the make-up air temperature setpoint, increasing the minimum make-up airflow. If the sensed make-up air temperature is not above the temperature setpoint, decreasing the minimum make-up airflow. If a burner gas valve outflow and burner enabling signal are accessible, there may be selective variation of the gas valve outflow, the burner status and the minimum make-up airflow.

### CROSS REFERENCE TO RELATED APPLICATION

This application claims the benefit under 35 U.S.C. §119(e) of Provisional Application Ser. No. 61/656,767, filed Jun. 7, 2012 which is hereby incorporated by reference in its entirety.

### FIELD OF THE INVENTION

The present invention relates to the field of methods for operating heating, ventilation and air conditioning (HVAC) systems. More particularly, it relates to methods to optimize and control HVAC systems.

### BACKGROUND

The heating of commercial or industrial building spaces, often requires large amounts of make-up air to compensate for heated air loss through open doors, chimney flues and/or exhaust fans. This is especially true in the case of commercial or industrial kitchens, where large amount of air must be exhausted to evacuate undesirable by-products resulting from cooking.

It is known in the art to use variable-speed direct gas-fired air-handling units to intake fresh air from outside of the building, heat the intake air to a predetermined temperature setpoint and release the heated intake air into the inside space of the building, to compensate for the exhausted air.

Known HVAC systems used in the above-described environment typically exhibit several drawbacks. Firstly, in order to minimize the energy loss through over-exhaustion of heated inside air, demand control ventilation systems are frequently used. Such systems monitor several parameters (e.g. temperature, air quality, presence of gas and fumes, or the like), by means of various sensors, and modulate the speeds of exhaust and intake fans, according to the sensed data.

In some instances, there may be a difference between the exhaust needs related to the temperature and those of other parameters related to the by-products of cooking. For example, especially when the heat radiated by cooking appliances elevates said temperature by several degrees, the ambient temperature may be uncomfortable, while minimal by-product of cooking are generated. In such cases, increasing exhaust and intake fans speeds, solely because the temperature is too hot, results in a loss of potential energy savings, since such an increase is not related to air quality or presence of gas and/or fumes.

Moreover, in order to heat the intake air, direct gas-fired air-handling units, commonly using raw-gas burners, installed directly in the air stream are commonly used. In such devices, the raw-gas burner supplies gaseous fuel to the flame and the main air stream supplies the oxygen required for proper combustion. Constant monitoring of air pressure drop across the burner is performed to ensure that an appropriate amount of oxygen is supplied in order to maintain the minimal necessary air-fuel mixture for proper combustion.

A condition known as low fire condition occurs when the gas outflow allowed by the burner modulating valve of the burner reaches its lower threshold.

In variable-speed units, control of the pressure drop across the burner is maintained over a wide range of airflows by allowing a damper-controlled bypass of fresh air around the burner. For example, such a system is described in U.S. Pat. No. 4,917,074, which is incorporated herein by reference.

Minimum make-up airflow is reached when the modulating dampers of the bypass are completely closed, and the pressure drop across the burner reaches its lower threshold.

Given that pressure drop requirements are directly related to the required air-fuel mixture for proper combustion, the pressure drop requirement becomes irrelevant when the burner is not in operation. This consideration results in the minimum make-up airflow being significantly lowered. However, known demand control ventilation systems do not take into account the burner status in the determination of the minimum make-up airflow, which consequently results in a loss of potential energy savings.

In addition, when the minimum make-up airflow is superior to the minimum airflow of the corresponding exhaust fans, the demand control ventilation system must nevertheless match the total amount of exhausted air with the amount of intake air in order to maintain proper pressure conditions in the building. In some instance, this requirement results in unnecessary exhaustion of inside air, in order to match the exhausted airflow with the minimum make-up airflow. This therefore also results in a loss of potential energy savings when low ventilation demand occurs.

In addition, experience has shown that when minimum make-up airflow is required, the burner low fire induces a significant minimum temperature rise. This temperature rise is especially undesirable during mild weather conditions.

Finally, over time, the components of the intake air system may become less efficient due to different factors such as, without being limitative, dirt or grease lodged in the intake filter or degradation of the mechanical component of the intake fans. In this case, the system may need to be tuned to compensate this lost efficiency. Hence, known systems currently require manual tuning at regular intervals.

In view of the above, there is a need for an improved automation and optimization control method for heating, ventilation, and air conditioning system which would be able to overcome or at least minimize some of the above-discussed prior art concerns.

### SUMMARY

According to a general aspect, there is provided a method for controlling a variable-speed direct gas-fired air-handling unit of a HVAC system having a minimum make-up airflow. The method comprises the steps of:
introducing a make-up airflow having a make-up air temperature in a space;
sensing the make-up air temperature;
comparing the sensed make-up air temperature to a make-up air temperature setpoint;
increasing the minimum make-up airflow if the sensed make-up air temperature is above the make-up air temperature setpoint;
otherwise, decreasing the minimum make-up airflow.

In an embodiment, the method further comprises:
sensing an ambient air temperature in the space;
comparing the sensed ambient air temperature to an ambient temperature setpoint;
decreasing the make-up air temperature setpoint if the sensed ambient air temperature is above the ambient temperature setpoint; and
otherwise, increasing the make-up air temperature setpoint.

In an embodiment, the space comprises a kitchen space with at least one cooking appliance.

According to another general aspect, there is also provided a method for controlling a variable-speed direct gas-fired air-handling unit of a HVAC system in gas communication with a space, the variable-speed direct gas-fired air-handling unit including a burner having a burner status and a burner gas valve outflow with a gas valve lower limit, bypass dampers, and a minimum make-up airflow having a higher limit and a lower limit. The method comprises the steps of:
introducing a make-up airflow having a make-up air temperature in the space;
sensing the make-up air temperature;
comparing the sensed make-up air temperature to a make-up air temperature setpoint;
if the sensed make-up air temperature is above the make-up air temperature setpoint;
   monitoring the burner status to determine if the burner is active or inactive;
   if the burner is inactive, increasing the minimum make-up airflow;
   if the burner is active and the gas valve outflow has not reached the gas valve lower limit, performing one of decreasing the gas valve outflow and decreasing a gas valve position setpoint;
   if the burner active, the gas valve outflow has reached the gas valve lower limit and the minimum make-up airflow has not reached the minimum make-up airflow higher limit, increasing the minimum make-up airflow; and
if the make-up air temperature is not above the make-up air temperature setpoint;
   decreasing the minimum make-up airflow.

In an embodiment, the method further comprises triggering a burner extinction process if the sensed make-up air temperature is above the make-up air temperature setpoint, the burner is active, the gas valve outflow has reached the gas valve lower limit and the minimum make-up airflow has reached the minimum make-up airflow higher limit.

In an embodiment, the burner extinction process comprises the steps of:
determining if the burner has been active for longer than a predetermined ON-time period;
if the burner has been active for longer than the predetermined ON-time period:
   powering off the burner; and
   resetting the minimum make-up airflow to the minimum make-up
   airflow lower limit.

In an embodiment, if the make-up air temperature is below the make-up air temperature setpoint, the method further comprises:
monitoring the burner status to determine if the burner is active or inactive;
if the burner is active, performing one of increasing the gas valve outflow and increasing the gas valve position setpoint; and
if the burner is inactive, triggering a burner ignition process.

In an embodiment, the burner ignition process comprises:
determining if a difference between the make-up air temperature and the make-up air temperature setpoint is above a dead band width; and
if the difference between the make-up air temperature and the make-up air temperature setpoint is above the dead band width, igniting the burner.

In an embodiment, the method further comprises determining the dead band width based on a minimum increase in the make-up air temperature when the burner is active.

In an embodiment, the burner ignition process further comprises the steps of:
increasing at least one of a burner pressure drop setpoint and a burner pressure drop limit before igniting the burner; and
resetting the at least one of the burner pressure drop setpoint and the burner pressure drop limit after ignition of the burner.

In an embodiment, the method further comprises:
sensing an ambient air temperature in the space;
comparing the sensed ambient temperature to an ambient temperature set-point;
if the ambient air temperature is above an ambient temperature setpoint, decreasing the make-up air temperature setpoint; and
otherwise, increasing the make-up air temperature setpoint.

In an embodiment, the method further comprises:
monitoring at least one of a frequency and an amplitude of burner pressure drops in the HVAC system; and
triggering a wind squall control process when the at least one of the frequency and the amplitude of the burner pressure drops is above a threshold value for a predetermined time period.

In an embodiment, the wind squall control process comprises:
adjusting at least one of a burner pressure drop setpoint and a burner pressure drop limit; and
resetting the at least one of the burner pressure drop setpoint and the burner pressure drop limit to its initial value when the at least one of the frequency and the amplitude of the burner pressure drops is above the threshold value.

In an embodiment, adjusting the at least one of the burner pressure drop setpoint and the burner pressure drop limit is performed by decreasing the at least one of the burner pressure drop setpoint and the burner pressure drop limit.

In an embodiment, the space comprises a kitchen space with at least one cooking appliance.

According to another general aspect, there is also provided a method for controlling a variable-speed direct gas-fired air-handling unit of a HVAC system in gas communication with a kitchen space and including a supply fan blowing a make-up airflow in the space and having low and high speed limits and a burner, the method comprising the steps of:
receiving a required make-up airflow value;
calculating a supply fan speed command based on the received required make-up airflow value;
monitoring a burner status to determine if the burner is active or inactive;
if the burner is active, updating the supply fan speed command according to the high and low speed limits; and
modulating the supply fan speed according to the calculated supply fan speed command.

In an embodiment, the method further comprises
determining a kitchen pressure offset; and
updating the supply fan speed command according to the kitchen pressure offset.

In an embodiment, the supply fan is characterized by a balancing point A characterized by a speed and a flow and a balancing point B characterized by a speed and a flow and wherein calculating the supply fan speed command comprises the steps of:
determining a kitchen pressure offset;
if the supply fan speed command is above the speed corresponding to the balancing point B and the kitchen pressure offset is positive, increasing the flow corresponding to the balancing point B;
if the supply fan speed command is above the speed corresponding to the balancing point B and the kitchen pressure offset is negative, decreasing the flow corresponding to the balancing point B;
if the supply fan speed command is not above the speed corresponding to the balancing point B and is below the speed corresponding to the balancing point A and the kitchen pressure offset is positive, increasing the flow corresponding to the balancing point A;
if the supply fan speed command is not above the speed corresponding to the balancing point B and is below the speed corresponding to the balancing point A and the kitchen pressure offset is negative, decreasing the flow corresponding to the balancing point A;
if the supply fan speed command is between the speeds corresponding to the balancing point A and the balancing point B and the kitchen pressure offset is positive, increasing the flows corresponding to the balancing point A and the balancing point B; and
if the supply fan speed command is between the speeds corresponding to the balancing point A and the balancing point B and the kitchen pressure offset is negative, increasing the flows corresponding to the balancing point A and the balancing point B.

In an embodiment, the method further comprises:
determining a kitchen pressure offset;
sensing a differential pressure between the atmospheric pressure and a kitchen space;
if the differential pressure is greater than a predetermined pressure differential threshold, increasing the kitchen pressure offset;
if the differential pressure is not greater than the predetermined pressure differential threshold, decreasing the kitchen pressure offset.

In an embodiment, the method further comprises:
sensing a pressure drop across the burner;
monitoring a burner status to determine if the burner is active or inactive; and
if the burner is active:
   if the pressure drop across the burner is above a high pressure drop limit, decreasing the high speed limit of the supply fan;
   if the pressure drop across the burner is below a low pressure drop limit, increasing the low speed limit of the supply fan;
   if the pressure drop across the burner is between the low pressure drop limit and the high pressure drop limit and the supply fan speed command is higher or equal to the high speed limit of the supply fan, increasing the high speed limit of the supply fan;
   if the pressure drop across the burner is between the low pressure drop limit and the high pressure drop limit and the supply fan speed command is lower or equal to the low speed limit of the supply fan, decreasing the low speed limit of the supply fan.

According to another general aspect, there is also provided a method for controlling a variable-speed direct gas-fired air-handling unit of a HVAC system in gas communication with a space, the method comprising the steps of:

introducing a make-up airflow having a make-up air temperature in the space;
sensing an ambient air temperature in the space;
comparing the sensed ambient air temperature with an ambient air temperature set-point;
if the sensed ambient air temperature is above the ambient air temperature set-point, decreasing a make-up air temperature set-point;
otherwise, increasing the make-up air temperature set-point.

In an embodiment, the method further comprises:
sensing the make-up air temperature;
comparing the sensed make-up air temperature to the make-up air temperature setpoint;
increasing a minimum make-up airflow if the sensed make-up air temperature is above the make-up air temperature setpoint;
otherwise, decreasing the minimum make-up airflow.

In an embodiment, the space comprises a kitchen space with at least one cooking appliance.

In an embodiment, the variable-speed direct gas-fired air-handling unit comprises a burner having a burner status and a burner gas valve outflow with a gas valve lower limit, bypass dampers, and a minimum make-up airflow having a higher limit and a lower limit, the method comprising the steps of:
sensing the make-up air temperature;
comparing the sensed make-up air temperature to a make-up air temperature setpoint;
if the sensed make-up air temperature is above the make-up air temperature setpoint;
   monitoring the burner status to determine if the burner is active or inactive;
   if the burner is inactive, increasing the minimum make-up airflow;
   if the burner is active and the gas valve outflow has not reached the gas valve lower limit, performing one of decreasing the gas valve outflow and decreasing a gas valve position setpoint;
   if the burner is active, the gas valve outflow has reached the gas valve lower limit and the minimum make-up airflow has not reached the minimum make-up airflow higher limit, increasing the minimum make-up airflow; and
if the make-up air temperature is not above the make-up air temperature setpoint;
   decreasing the minimum make-up airflow.

In an embodiment, the method further comprises triggering a burner extinction process if the sensed make-up air temperature is above the make-up air temperature setpoint, the burner is active, the gas valve outflow has reached the gas valve lower limit and the minimum make-up airflow has reached the minimum make-up airflow higher limit.

In an embodiment, the burner extinction process comprises the steps of:
determining if the burner has been active for longer than a predetermined ON-time period;
if the burner has been active for longer than the predetermined ON-time period:
   powering off the burner; and
   resetting the minimum make-up airflow to the minimum make-up airflow lower limit.

In an embodiment, if the make-up air temperature is below the make-up air temperature setpoint, the method further comprises:
monitoring the burner status to determine if the burner is active or inactive;
if the burner is active, performing one of increasing the gas valve outflow and increasing the gas valve position setpoint; and
if the burner is inactive, triggering a burner ignition process.

In an embodiment, the burner ignition process comprises:
determining if a difference between the make-up air temperature and the make-up air temperature setpoint is above a dead band width; and
if the difference between the make-up air temperature and the make-up air temperature setpoint is above the dead band width, igniting the burner.

In an embodiment, the method further comprises determining the dead band width based on a minimum increase in the make-up air temperature when the burner is active.

In an embodiment, the burner ignition process further comprises the steps of:
increasing at least one of a burner pressure drop setpoint and a burner pressure drop limit before igniting the burner; and
resetting the at least one of the burner pressure drop setpoint and the burner pressure drop limit after ignition of the burner.

In an embodiment, the method further comprises:
monitoring at least one of a frequency and an amplitude of burner pressure drops in the HVAC system; and
triggering a wind squall control process when the at least one of the frequency and the amplitude of the burner pressure drops is above a threshold value for a predetermined time period.

In an embodiment, the wind squall control process comprises:
adjusting at least one of a burner pressure drop setpoint and a burner pressure drop limit; and
resetting the at least one of the burner pressure drop setpoint and the burner pressure drop limit to its initial value when the at least one of the frequency and the amplitude of the burner pressure drops is above the threshold value.

In an embodiment, the method further comprises:
sensing a pressure drop across the burner;
monitoring a burner status to determine if the burner is active or inactive; and
if the burner is active:
   if the pressure drop across the burner is above a high pressure drop limit, decreasing the high speed limit of the supply fan;
   if the pressure drop across the burner is below a low pressure drop limit, increasing the low speed limit of the supply fan;
   if the pressure drop across the burner is between the low pressure drop limit and the high pressure drop limit and the supply fan speed command is higher or equal to the high speed limit of the supply fan, increasing the high speed limit of the supply fan;
   if the pressure drop across the burner is between the low pressure drop limit and the high pressure drop limit and the supply fan speed command is lower or equal to the low speed limit of the supply fan, decreasing the low speed limit of the supply fan.

### BRIEF DESCRIPTION OF THE DRAWINGS

Other objects, advantages and features of the present invention will become more apparent upon reading the following non-restrictive description of preferred embodiments thereof, given for the purpose of exemplification only, with reference to the accompanying drawings in which:

FIG. 1 is a schematic side elevation representation of a kitchen with a variable-speed direct gas-fired air-handling unit, according to an embodiment.

FIG. 2 is a flowchart representation of a method for controlling a make-up air temperature setpoint in a HVAC system, according to an embodiment.

FIG. 3 is a flowchart representation of a method for controlling a make-up air temperature in a HVAC system, according to an embodiment.

FIG. 4 includes FIGS. 4A and 4B and is a flowchart representation of a method for controlling a make-up air temperature in a HVAC system, according to an embodiment where adjustments of a burner gas valve outflow and monitoring and modification of a burner status are available to the control system.

FIG. 5 is a flowchart representation of a method for controlling the supply fan speed command in a HVAC system, according to an embodiment.

FIG. 6 is a flowchart representation of a method for controlling a flow of balancing points, used in the determination of a supply fan speed command from a make-up airflow, according to an embodiment.

FIG. 7 is a graphical representation of a function for determining a supply fan speed command from a make-up airflow, according to an embodiment.

FIG. 8 is a flowchart representation of a method for controlling a pressure offset for a space, according to an embodiment.

FIG. 9 is a flowchart representation of a method for controlling supply fan speed limits, according to an embodiment.

### DETAILED DESCRIPTION

In the following description, the same numerical references refer to similar elements. The embodiments, geometrical configurations, materials mentioned and/or dimensions shown in the figures or described in the present description are preferred embodiments only, given solely for exemplification purposes.

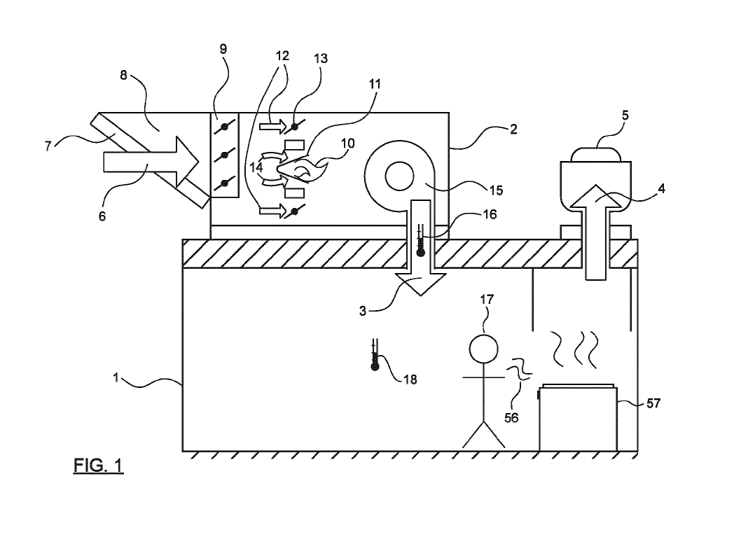

Referring to FIG. 1, an institutional or industrial kitchen space 1, such as, without being limitative, a restaurant kitchen is shown. The kitchen is equipped with a variable-speed direct gas-fired air-handling unit 2, controlled by a control system having a controller (not shown), that provides a make-up air (also referred as “MUA”) flow 3 to the building. The demand control ventilation system can be summarily described as a system for regulating the speeds of an exhaust fan 5 and a supply fan 15, if any. The variable-speed direct gas-fired air-handling unit 2 is understood to be a unit having a supply fan 15 of variable speed and where heating of a corresponding airflow, referred to as a make-up airflow 3, is provided through a gas generated flame 10 located within the path of the airflow. The make-up airflow 3 compensates for the loss of inside air 4 (or exhaust air flow) in the kitchen space 1 that is exhausted by the exhaust fan 5, or through other apertures provided in a housing defining the kitchen space 1. One skilled in the art will understand that the make-up airflow 3 can be heated or not.

In the illustrated embodiment, the variable-speed direct gas-fired air-handling unit 2 is provided with an inlet weather hood 8. Outside air 6 enters the building through a filter section 7 provided in the inlet weather hood 8, and proceeds through an outside air damper section 9. The outside airflow 6 is subsequently divided in two portions. A first portion 14 of the outside airflow 6 is directed through a heating path where the airstream 14 crosses the gas generated flame 10. The intensity of the gas generated flame 10 is controlled by a raw-gas burner 11. A second portion 12 of the outside airflow 6 goes through a bypass path defined around the burner 11. The airflow 12 of the bypass path is regulated by adjustable/controllable bypass dampers 13. Control of the bypass airflow 12 in the bypass path by the adjustable/controllable bypass dampers 13, results in control of the heated airflow 14 in the heating path to maintain the required airflow across the burner 11 and ensure proper combustion.

As mentioned above, the flame 10 reaches low fire condition when a burner gas valve outflow allowed by a burner modulating valve (not shown) reaches its lower limit. When the burner 11 is active, the make-up airflow reaches its lower limit when the adjustable/controllable bypass dampers 13 are in a fully closed configuration, and the pressure drop across the burner 11 caused by the airflow 14 reaches its lower limit. For example and without being limitative, the lower limit of the pressure drop across the burner 11 can be approximately 0.15 kilopascal (approximately 0.6 inches of water).

The supply fan 15 draws the outside air 6 into the variable-speed direct gas-fired air-handling unit 2 and blows the make-up airflow 3 including heated air, if any, into the kitchen space 1. In an embodiment, the speed of the supply fan 15 is controlled by the demand control ventilation system (not shown), and is modulated such that the make-up airflow 3 blown by the supply fan 15 matches the airflow of the exhaust fan 5 in order to maintain a constant pressure inside the kitchen space 1.

As mentioned above, since the supply fan 15 has a minimum airflow restriction (based on the minimum airflow required across the burner 11), the exhaust fan airflow 4 cannot be lower than that of the supply fan airflow. Therefore, ventilation demands from the exhaust fan 5 which are below the minimum airflow do not generate additional energetic savings.

In the system shown in FIG. 1, the temperature 16 of the make-up airflow 3 is modulated by a control loop in order to reach a predetermined temperature setpoint. In operation, the temperature setpoint is reached by modulation of the flame 10, using the burner modulating valve (not shown) which controls the burner gas valve outflow, to provide an ambient air temperature 18 that is comfortable for the individuals 17 present in the kitchen space 1.

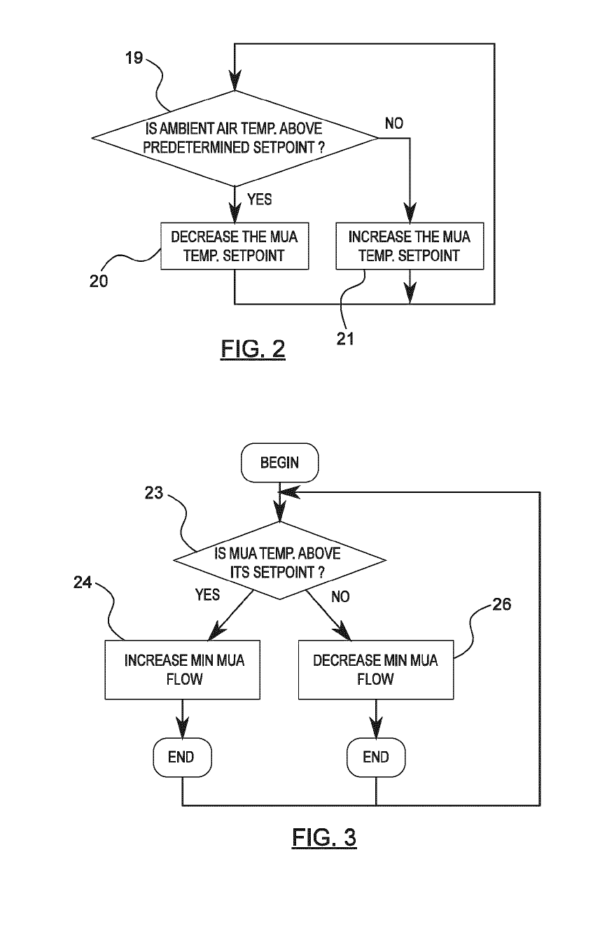

Now referring to FIG. 2, there is shown a control method for controlling a make-up air temperature setpoint, according to an embodiment. More particularly, FIG. 2 shows a schematic control method used by the demand control ventilation system in order to regulate the ambient air temperature 18 (the controlled variable) by varying the make-up air temperature setpoint 16 (the actuated variable). One skilled in the art will understand that the control method can include controllers, such as, without being limitative, a PID, an adaptive predictive controller, a neural network controller or the like.

As can be easily understood, the required variation of the make-up air temperature setpoint 16 is based on the difference between the ambient air temperature 18 and the ambient air setpoint. Therefore, an initial step of determination of the required temperature variation (step 19) is performed. In this initial step, the ambient air temperature 18 is compared to the ambient air temperature setpoint. The make-up air temperature setpoint is subsequently adjusted (steps 20, 21). The make-up air temperature setpoint is decreased when the ambient air temperature 18 is above the temperature setpoint (as referenced in step 20) and is increased when the ambient air temperature 18 is lower than the temperature setpoint (as referenced in step 21).

It should be noted that, in an embodiment, the increase and decrease increments referenced by steps 20 and 21 are fixed values. In an alternative embodiment the increase and decrease increments referenced by steps 20 and 21 can also be variable values calculated according to controller settings. As mentioned above, the controller can be a PID, an adaptive predictive controller, a neural network controller or the like. Moreover, in an embodiment, appropriate upper and lower limits can be set in the control system for every setpoint and/or actuator(s).

The control period of the control loop shown in FIG. 2 can be selected in accordance with a user's needs.

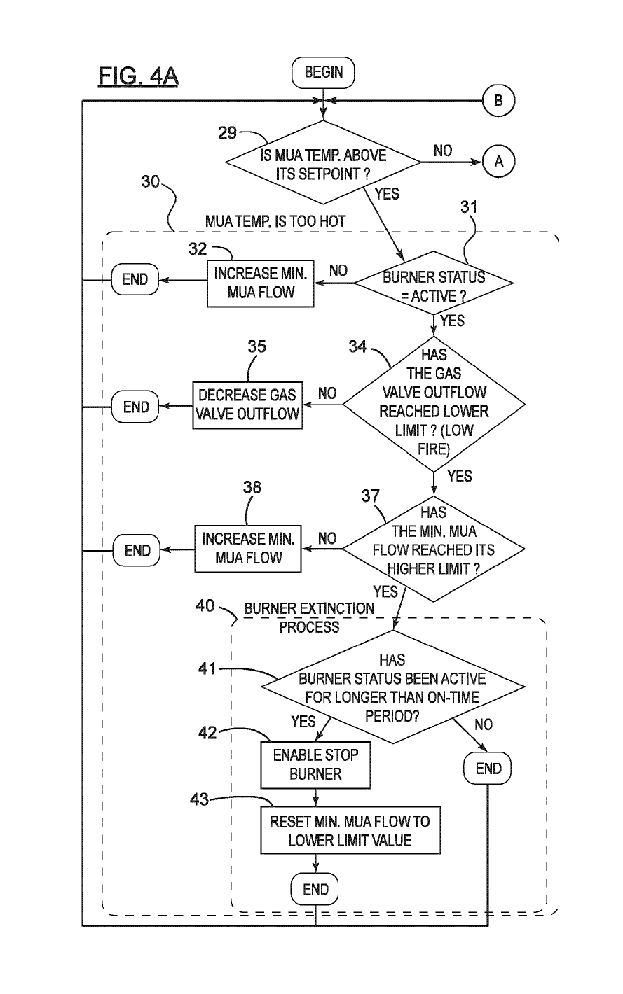

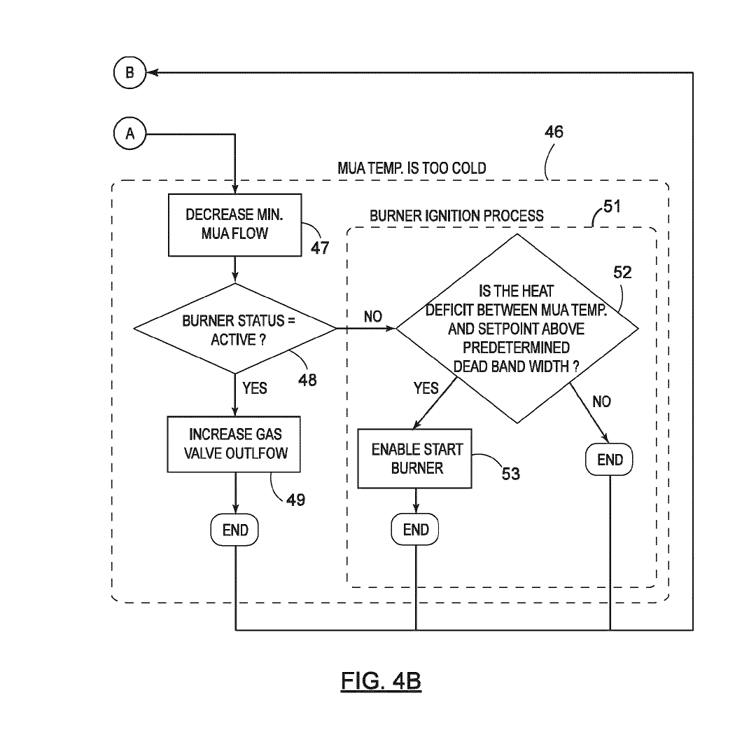

FIG. 3 and FIG. 4 present two different control strategies, according to mutually-exclusive alternative embodiments, which may be used to control the make-up air temperature such that it is maintained as close as possible to its setpoint (which is varied in accordance with the control method shown in FIG. 2, and detailed above). As can be seen, the strategies shown in FIG. 3 and FIG. 4 are iterative (i.e. in both cases a new iteration begins every time an end step is reached). The control period is an adjustable variable that can be selected in accordance with a user's needs.

The make-up airflow is controlled to be as close as possible to the minimum make-up airflow and, thereby, increase energy savings. However, the make-up air temperature is controlled by varying the minimum make-up airflow, instead of the make-up airflow. By adjusting the minimum make-up airflow, the make-up airflow, which tends to be as close as possible to the minimum make-up airflow, is simultaneously controlled.

Once again, according to an embodiment, the increase and decrease increments performed in steps 24, 26, 32, 35, 38, 47 and 49 of FIGS. 3 and 4, and which will be described below, are variable values calculated according to the relevant settings of the controller, which can be any of the above-listed controllers or alternatives thereof. In an alternative embodiment, the increase and decrease increments could also be fixed values. Moreover, appropriate lower and upper limits can be set in the control system for every setpoint and/or actuators. In operation, these limits should not be exceeded.

Referring to FIG. 3, there is shown a control method to be carried by a control system including a controller (not shown). The control method shown in FIG. 3 provides an initial step of determining if the make-up air temperature 16 is above its setpoint (step 23). This step is performed by sensing the make-up air temperature 16 of the system and comparing the sensed make-up air temperature 16 to the make-up air temperature setpoint. The minimum make-up airflow is subsequently increased (step 24), by the controller, when the make-up air temperature is above its setpoint and is decreased (step 26) by the controller when it is not.

In order to provide energy savings, unless excessive ambient heat requires an increase in make-up airflow, as mentioned above, the control method aims at preserving the make-up airflow as low as permitted. Therefore, by default, the controller is set to provide a slow gradual decrease of the minimum make-up airflow (at step 26) until the lower limit is reached. However, the control method avoids an excessive ambient temperature 18 by preventing both exhaust 4 and make-up 16 airflows from an excessive decrease. This is achieved by a gradual increase of the minimum make-up airflow 24 when the make-up air temperature is greater than its setpoint. For example, and without being limitative, the rate of the gradual decrease or increase can be such that the entire possible range of make-up airflow could be covered in approximately 5 to 20 minutes.

The above-described control method in reference to FIG. 3 is mainly used when the direct gas-fired air-handling unit manufacturer does not provide any control points to the variable-speed direct gas-fired air-handling unit 2 by external systems (i.e. the control points cannot be remotely adjusted). Therefore in this control method, regulation is obtained by varying the minimum make-up airflow.

Now referring to FIG. 4, there is shown an alternative control method to be carried out by a control system, according to another embodiment. The control method shown in FIG. 4 takes advantage of the ability to remotely control the burner gas valve outflow and monitor a burner enabling signal (which is a signal indicative of the status of the burner, i.e. active or inactive) by the control system, in order to provide improved control of the make-up air temperature setpoint. Therefore, in the process shown in FIG. 4, the make-up air temperature setpoint is controlled by varying selectively the burner gas valve outflow, the burner status and/or the minimum make-up airflow. For example, in the embodiment shown in FIG. 4, the control method responds to an excess of heat, express by an ambient air temperature 18 above its set-point, by gradually increasing the minimum make-up airflow (up to its maximum value), and, if necessary, extinguishing the flame of the burner.

In the embodiment shown in FIG. 4, the control method begins by determining if the make-up air temperature 16 is above its setpoint, i.e. the make-up air temperature 16 needs to be decreased in order to reach the predetermined setpoint (step 29). This step is performed by sensing the make-up air temperature 16 of the system 2 and comparing the measured make-up air temperature to the make-up air temperature setpoint.

When a make-up air temperature decrease is required (referenced by the steps grouped under reference number 30), the control system proceeds to a feedback reading of the burner enabling signal to monitor the burner status (step 31). If the burner is inactive, the controller gradually increases the minimum make-up airflow (step 32). One skilled in the art will understand that step 32 of gradual increase of the minimum make-up airflow by the controller is similar to step 24 shown in FIG. 3 and described above.

In the situation where the burner is active (determined at step 31) and a low fire condition has not been reached (determined at step 34), i.e. the burner gas valve outflow has not reached a gas valve lower limit, the controller decreases the burner gas valve outflow (step 35). If the burner is already in low fire condition (determined at step 34), i.e. no further decrease of the burner gas valve outflow is permitted since the burner gas valve outflow has reached its gas valve lower limit, the controller gradually increases the minimum make-up airflow (step 38), until the higher limit is reached. Once again, one skilled in the art will understand that this step 38 of increasing the minimum make-up airflow is similar to steps 24 shown in FIG. 3 and step 32 of FIG. 4.

In the alternative where the minimum make-up airflow has already reached its higher limit (as determined at step 37), a burner extinction process (referenced by the steps grouped under reference number 40) is initiated. The first step of the burner extinction process 40 is a verification of the predetermined burner ON-time requirement (step 41), to determine if the burner has been active for at least a predetermined time period. For example, and without being limitative, the predetermined time period can range between 20 and 30 minutes. If the predetermined burner ON-time requirement is met, the controller triggers a burner extinguishing signal to proceed with extinguishing the burner (step 42) and resets the minimum make-up airflow to its low limit value (step 43). If the predetermined burner ON-time requirement 41 is not met, no action is taken.

In the situation where decrease of the make-up air temperature 16 is not required, i.e. the make-up air temperature 16 is not above the make-up air temperature setpoint (referenced by the steps grouped under reference number 46), the controller gradually decreases the minimum make-up airflow (step 47) until its lower limit is reached, to allow for optimal energy savings. One skilled in the art will understand that this process is similar to the default slow gradual decrease of minimum make-up airflow provided at step 26 of the process shown in FIG. 3. Lowering of the minimum make-up airflow allows for lower make-up airflow 3 and exhaust flow 4, which results in the ambient air temperature 18 rise due to radiated heat 56 from cooking appliances 57 (see FIG. 1). This is convenient when heating of the ambient air is actually required.

If supplemental heat is required (despite the gradual lowering of the minimum make-up airflow), the control system performs a feedback reading of the burner enabling signal to monitor the burner status (step 48). If the burner is active, the controller increases the burner gas valve outflow (step 49). In the default configuration, monitoring of the burner status is always performed following the step of gradually decreasing the minimum make-up airflow.

However, in an alternative embodiment (not shown), the determination of whether supplemental heat is required could be performed by a comparison of the ambient temperature 18 and the ambient temperature setpoint. In such an alternative embodiment, monitoring of the burner status and the subsequent corresponding steps could be performed only when the difference in temperature is greater than a predetermined threshold.

In the situation where the burner is inactive (as determined at step 48), the control system initiates the burner ignition process (referenced by the steps grouped under reference number 51), with a dead band width verification (step 52). The dead band width verification 52 determines whether the heat required for the make-up air temperature 16 to reach its setpoint is greater than a predetermined dead band width, based on the low fire minimum temperature increase when make-up airflow 3 is at its higher limit. In other words, the dead band width verification 52 determines whether the required increase in temperature is superior to the increase in temperature created by the burner running at low fire condition and the make-up airflow 3 being at its maximum limit. When the dead band width verification 52 is positive, the controller triggers the burner ignition signal (step 53) to ignite the burner. If not, no action is taken.

One skilled in the art will understand that, in an alternative embodiment, the predetermined dead band width could be set manually to a value higher than the low fire minimum temperature increase when make-up airflow 3 is maximal at its higher limit.

In order to lower the rate of alarm occurrences during the burner ignition process, in an embodiment, a further control process (not shown) may be provided in connection with the ignition process. The ignition control process aims at controlling the pressure drop across the burner during a predetermined time period preceding and following the ignition of the burner, in order to ensure that the additional pressure drop caused by the ignition of the burner does not trigger a low pressure alarm. For example, and without being limitative, the predetermined time period may range from approximately 30 seconds to 2 minutes. The ignition control process comprises a control loop for determining the pressure drop across the burner and controlling the outside air damper section 9, the adjustable/controllable bypass dampers 13, the speed of the fan 15, the supply fan high and low speed limits, and any other element impacting on the pressure drop across the burner, during the predetermined time period, to ensure that the pressure drop setpoint and/or its limits are slightly raised to prevent ignition-induced low pressure alarms.

In an embodiment, in order to further reduce the rate of alarm occurrences during the burner ignition process, the ignition control process further includes the step of slightly increasing the pressure drop setpoint and/or its limits before the ignition of the burner and resetting the pressure drop setpoint and/or its limits to its original value after ignition of the burner.

In an embodiment, the HVAC system may prevent direct control of the burner gas valve outflow by an external controller and only allow adjustment of gas valve position setpoint. In this embodiment, the control method would differ from the one described above in reference to FIG. 4 in that an increase of the gas valve position setpoint would replace the steps of increasing the burner gas valve outflow and a decrease of the gas valve position setpoint would replace the steps of decreasing the burner gas valve outflow.

Similarly, in an embodiment, the HVAC system may prevent direct ignition/extinction of the burner by a remote controller. In this embodiment, the control method would differ from the one described above in that no burner extinction process and burner ignition process would be provided.

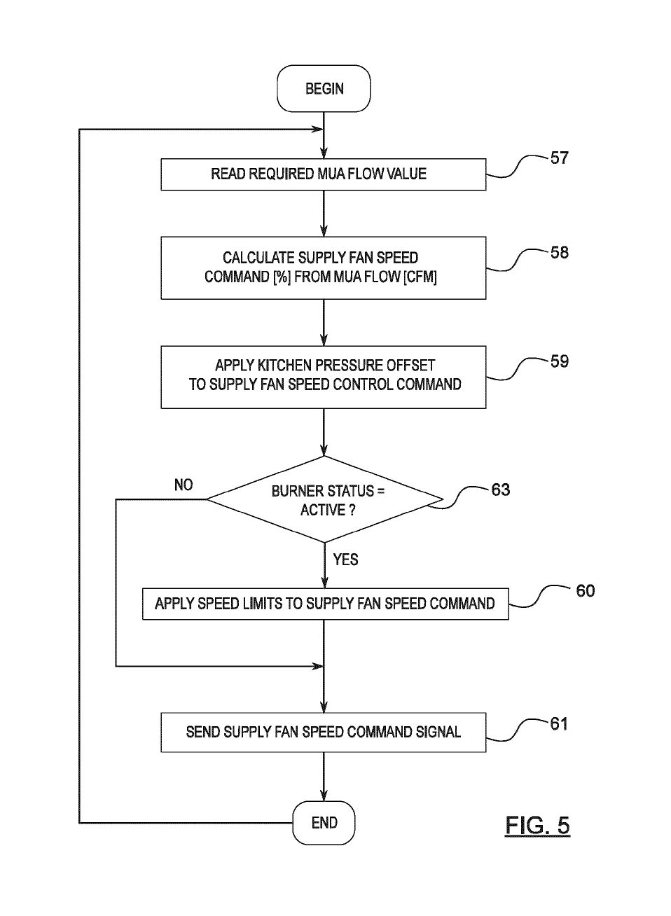

Now referring to FIGS. 5 to 9, in an alternative embodiment, the above described control methods can be supplemented by a further control method to be carried by the control system. The further control method aims at regulating the speed of the supply fan 15 generating the make-up airflow 3. Such a method is especially advantageous for compensating the loss of performance in air intake and distribution, due to mechanical considerations, such as, for example and without being limitative, partial clogging of the filter section or slackening of the intake fan belt. The compensation is provided by adjusting the speed of the supply fan 15 based on several parameters indicative of the airflow loss of the supply fan 15, such as, without being limitative, a kitchen pressure offset and the burner pressure drop, which will be described in more detail below. Finally, the process also helps preventing false alarms caused by changes in atmospheric or climatic conditions such as, without being limitative, sudden wind squalls. Therefore, one skilled in the art will understand that the control method may adjust the fan speed upwardly or downwardly.

In an embodiment, a wind squall control process (not shown) is also provided to reduce the rate of alarm occurrences caused by sudden wind squalls resulting in abrupt pressure drops in the HVAC system. The wind squall control process is triggered when the frequency and/or the amplitude of occurrence of pressure drops within a predefined time period are above predetermined limits. When triggered, the wind squall control process comprises a control loop for determining the pressure drop across the burner and controlling the outside air damper section 9, the adjustable/controllable bypass dampers 13, the speed of the fan 15, the supply fan high and low speed limits, and any other element impacting on the pressure drop across the burner, during a predetermined time period, to ensure that the pressure drop setpoint is slightly raised to prevent wind squall-induced low pressure alarms.

A kitchen differential pressure is monitored. The kitchen differential pressure can be defined as the difference between atmospheric pressure and ambient kitchen space 1 pressure. In an embodiment, the kitchen differential pressure is controlled according to a predetermined kitchen differential pressure set-point. The kitchen pressure offset is a variable correction, comprised within a predetermined range, that is applied to the MUA fan speed command, which in turn will impact the MUA speed signal, within predetermined high and low speed limits, which will ultimately modify the kitchen differential pressure.

As can be seen in FIG. 5, the control method for controlling the supply fan speed command comprises the iterative steps of receiving the required make-up airflow value (step 57), calculating a supply fan speed command (step 58) based on the received make-up airflow value and applying the kitchen pressure offset (step 59) to the supply fan speed command. Subsequently the control method comprises a step of monitoring the burner status to determine if the burner is active or inactive (step 63) and, if the burner is active, applying high/low speed limits (step 60) to the supply fan speed command. Finally, a step of sending a make-up air speed command signal (step 61) to the control system for modifying the supply fan speed is performed. In operation, application of pressure offset and speed limits require the pressure offset and speed limits to be determined by the control system and the supply fan speed command to be updated according to the determined values of these parameters. Once the make-up air speed command signal has been sent, the control of the supply fan speed is performed by modulating the supply fan speed according to the signal. In a non-limitative embodiment, the modulation of the speed of the supply fan 15 is performed using a variable frequency drive for controlling the frequency of the electrical power supplied to the fan motor.

The combination of all the control steps, described above as being part of the control method for regulating the supply fan speed, is advantageous in that it offers a control based on numerous parameters and therefore results in a more complete and efficient control. However, one skilled in the art will understand that, in an alternative embodiment, the steps of applying the kitchen pressure offset (step 59) to the supply fan speed command, and the step of monitoring the burner status (step 63), could be removed from the control method. In this alternative embodiment, the step of applying high/low speed limits (step 60) to the supply fan speed command would be performed without regard to the burner status. Therefore, the control method could be less efficient, but would remain advantageous in comparison to known systems. In an embodiment, the required make-up airflow value corresponds to the necessary exhaust airflow calculated by the system, using the values of several parameters related to the kitchen condition captured by designated captors at a specific time. However, in an alternative embodiment, the required make-up airflow value may be based on any other relevant values such as user-determined variables, external software or hardware points, and the like.

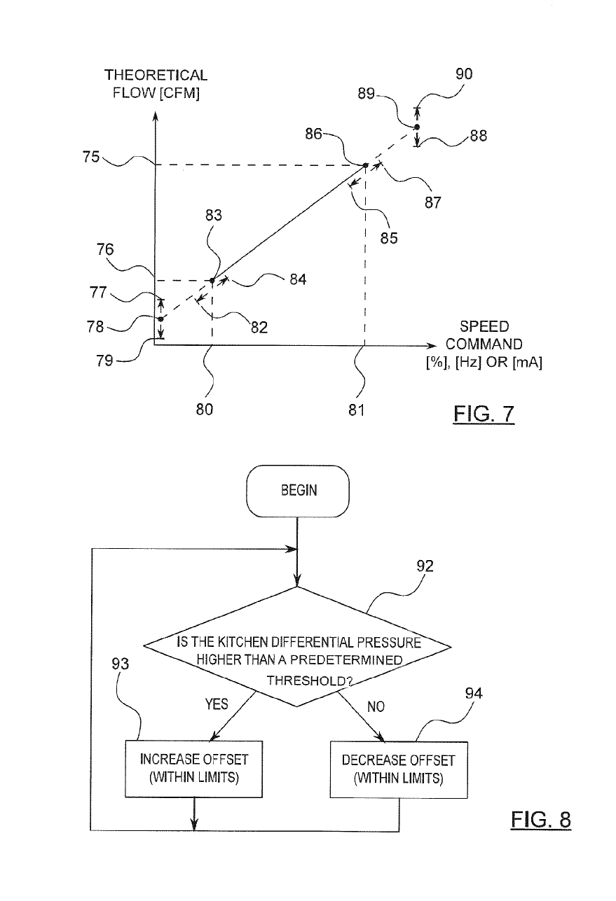

Still referring to the control method shown in FIG. 5, the calculation of the supply fan speed command (step 58), based on the received make-up airflow (step 57), is the result of a linear relation between a lower balancing point A and an upper balancing point B. The balancing points A and B represent reference values of the theoretical flow associated with a speed command of the supply fan 15. The relationship between the make-up airflow and the supply fan speed command is shown in the graphic of FIG. 7, where the reference number refer to the following elements: upper flow limit 75, upper speed limit 81, lower flow limit 76, lower speed limit 80, balancing point A 78, balancing point A upper flow limit 77, balancing point A lower flow limit 79, balancing point B 89, balancing point B upper flow limit 90, balancing point B lower flow limit 88. As can be seen, lower speed limit 83 can vary within limits 82 and 84, while upper speed limit 86 can vary within limits 85 and 87.

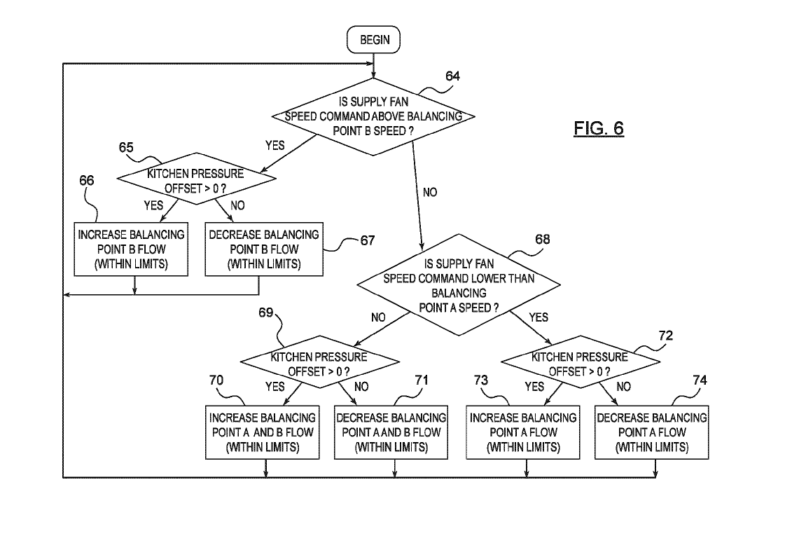

Now referring to FIG. 6, in the calculation of the supply fan speed command 58, the flow values of balancing points A and/or B may be increased or decreased in order to correct mechanical degradation occurring over time. The increase or decrease of the flow associated with balancing points A and/or B, is determined based on whether the supply fan speed command is greater than the balancing point B speed or lower than the balancing point A speed and whether the pressure offset in the kitchen space 1 is positive or negative.

In the case where the supply fan speed command is greater than the balancing point B speed (determined at step 64), a controller increases the balancing point B flow (step 66) if the pressure offset in the kitchen space 1 is positive (determined at step 65), and decrease the balancing point B flow (step 67) if the pressure offset in the kitchen space 1 is negative.

If the supply fan speed command is not greater than the balancing point B speed (determined at step 64), but the supply fan speed command is not lower than the balancing point A speed (determined at step 68), the controller increases both balancing point A flow and balancing point B flow (step 70) if the pressure offset in the kitchen space 1 is positive (determined at step 69), and decrease both balancing point A flow and balancing point B flow (step 71) if the pressure offset in the kitchen space 1 is negative.

In an embodiment, the ratio between the correction applied to balancing point A and the correction applied to balancing point B is proportional to the distance between the supply fan speed and the respective balancing point at the time of correction.

If the supply fan speed command is not above the balancing point B speed (determined at step 64) and the supply fan speed command is lower than the balancing point A speed (determined at step 68), the controller increases the balancing point A flow (step 73) if the pressure offset in the kitchen space 1 is positive (determined at step 72) and decrease the balancing point A flow (step 74) if the pressure offset in the kitchen space 1 is negative.

Variation rate of the flows associated with balancing points A and/or B will be slow, for example and without being limitative, a variation between the lower flow limits 79, 88 and the higher flow limits 77, 90 for either of balancing point A and/or B should require approximately 48 hours. Moreover, the flow variation will always result in the balancing point flow staying within the predetermined limits, i.e. between 79 and 77 for balancing point A and between 88 and 90 for balancing point B. Variation in the balancing point A and/or B flow will reflect in the supply fan speed command calculated based on the received make-up airflow (step 57).

Now referring to FIG. 8, the kitchen pressure offset applied at step 59 of FIG. 5 is controlled using a control method where the offset is increased by a controller (step 93) if the differential pressure in the kitchen space 1 is greater than a predetermined differential pressure threshold (determined at step 92), and is decreased by the controller (step 94) if the differential pressure in the kitchen space 1 (determined at step 92) is not greater than the predetermined differential pressure threshold. This offset value is used to regulate the supply fan speed in response to a short term difference in pressure in the kitchen space 1.

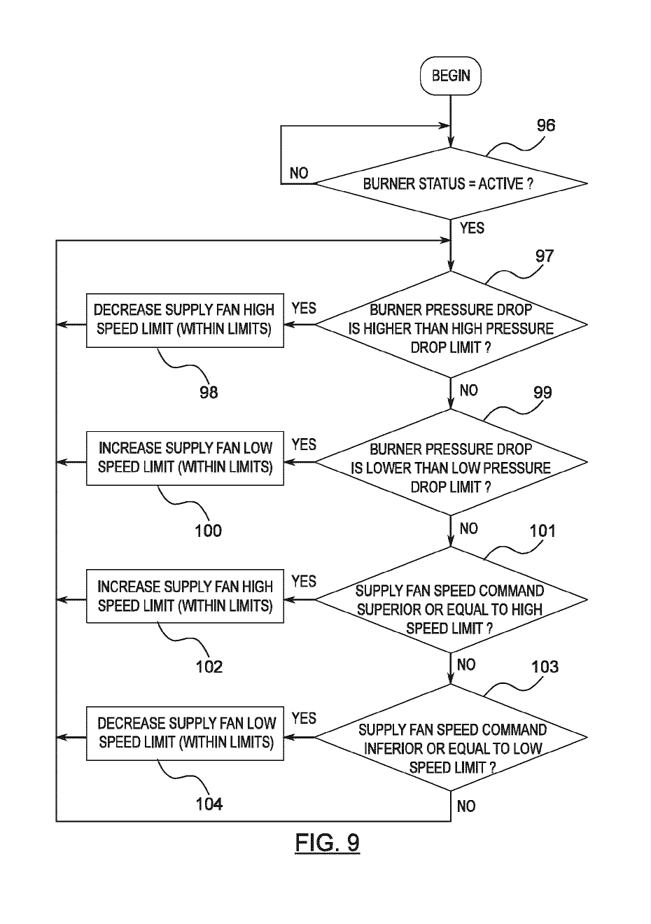

Finally referring to FIG. 9, the high/low speed limits of the supply fan speed command used in step 60 of FIG. 5 are determined using a control method based on the value of the pressure drop across the burner and the relation between the supply fan speed command and the speed limits. As can be seen in FIG. 9, the speed limits are modified only when the burner is active. One skilled in the art will understand that, in an embodiment where the value of the pressure drop across the burner cannot be read by the system, fixed values must be used for the supply fan high speed limit and the supply fan low speed limit. These fixed values can however be adjusted manually by a user. A monitoring of the burner status is therefore performed. When the burner is active (determined at step 96), the supply fan high speed limit is decreased by the controller (step 98) if the burner pressure drop is greater than the high pressure drop limit (determined at step 97), and the supply fan low speed limit is increased by the controller (step 100) if the burner pressure drop is lower than the low pressure drop limit (determined at step 99). When the burner is active (determined at step 96) and the pressure drop is within the prescribed limits (determined at steps 97 and 99), the supply fan high speed limit is increased by the controller (step 102) if the supply fan speed command is superior or equal to its high speed limit (determined at step 101), while the supply fan low speed limit is decreased by the controller (step 104) if the supply fan speed command is inferior or equal to its low speed limit (determined at step 103).

The process shown in FIG. 5, and the different steps further detailed in FIGS. 6 to 9, allows the control system to adjust the make-up air speed command to increase comfort of the individuals inside the regulated space. For example, the make-up air speed command may vary as a result of loss of performance in the intake and dispensing of air, offering a system that requires less manual tuning by technicians.

Several alternative embodiments and examples have been described and illustrated herein. The embodiments of the invention described above are intended to be exemplary only. A person skilled in the art would appreciate the features of the individual embodiments, and the possible combinations and variations of the components. A person skilled in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while specific embodiments have been illustrated and described, numerous modifications come to mind without significantly departing from the scope of the invention as defined in the appended claims.

1. A method for controlling a variable-speed direct gas-fired air-handling unit of a HVAC system having a minimum make-up airflow, the method comprising the steps of:
introducing a make-up airflow having a make-up air temperature in a space;
sensing the make-up air temperature;
comparing the sensed make-up air temperature to a make-up air temperature setpoint;
increasing the minimum make-up airflow if the sensed make-up air temperature is above the make-up air temperature setpoint;
otherwise, decreasing the minimum make-up airflow.

2. The method of claim 1, further comprising:
sensing an ambient air temperature in the space;
comparing the sensed ambient air temperature to an ambient temperature setpoint;
decreasing the make-up air temperature setpoint if the sensed ambient air temperature is above the ambient temperature setpoint; and
otherwise, increasing the make-up air temperature setpoint.

3. The method of claim 1, wherein the space comprises a kitchen space with at least one cooking appliance.

4. A method for controlling a variable-speed direct gas-fired air-handling unit of a HVAC system in gas communication with a space, the variable-speed direct gas-fired air-handling unit including a burner having a burner status and a burner gas valve outflow with a gas valve lower limit, bypass dampers, and a minimum make-up airflow having a higher limit and a lower limit, the method comprising the steps of:
introducing a make-up airflow having a make-up air temperature in the space;
sensing the make-up air temperature;
comparing the sensed make-up air temperature to a make-up air temperature setpoint;
if the sensed make-up air temperature is above the make-up air temperature setpoint;
monitoring the burner status to determine if the burner is active or inactive;
if the burner is inactive, increasing the minimum make-up airflow;
if the burner is active and the gas valve outflow has not reached the gas valve lower limit, performing one of decreasing the gas valve outflow and decreasing a gas valve position setpoint;
if the burner is active, the gas valve outflow has reached the gas valve lower limit and the minimum make-up airflow has not reached the minimum make-up airflow higher limit, increasing the minimum make-up airflow; and
if the make-up air temperature is not above the make-up air temperature setpoint;
decreasing the minimum make-up airflow.

5. The method of claim 4, further comprising triggering a burner extinction process if the sensed make-up air temperature is above the make-up air temperature setpoint, the burner is active, the gas valve outflow has reached the gas valve lower limit and the minimum make-up airflow has reached the minimum make-up airflow higher limit.

6. The method of claim 5, wherein the burner extinction process comprises the steps of:
determining if the burner has been active for longer than a predetermined ON-time period;
if the burner has been active for longer than the predetermined ON-time period:
powering off the burner; and
resetting the minimum make-up airflow to the minimum make-up airflow lower limit.

7. The method of claim 4, wherein if the make-up air temperature is below the make-up air temperature setpoint, the method further comprises:
monitoring the burner status to determine if the burner is active or inactive;
if the burner is active, performing one of increasing the gas valve outflow and increasing the gas valve position setpoint; and
if the burner is inactive, triggering a burner ignition process.

8. The method of claim 7, wherein the burner ignition process comprises:
determining a dead band width based on a minimum increase in the make-up air temperature when the burner is active;
determining if a difference between the make-up air temperature and the make-up air temperature setpoint is above the dead band width; and
if the difference between the make-up air temperature and the make-up air temperature setpoint is above the dead band width, igniting the burner.

9. (canceled)

10. The method of claim 8, wherein the burner ignition process further comprises the steps of:
increasing at least one of a burner pressure drop setpoint and a burner pressure drop limit before igniting the burner; and
resetting the at least one of the burner pressure drop setpoint and the burner pressure drop limit after ignition of the burner.

11. The method of claim 4, further comprising:
sensing an ambient air temperature in the space;
comparing the sensed ambient temperature to an ambient temperature set-point;
if the ambient air temperature is above an ambient temperature setpoint, decreasing the make-up air temperature setpoint; and
otherwise, increasing the make-up air temperature setpoint.

12. (canceled)

13. The method of claim 4, further comprising:
monitoring at least one of a frequency and an amplitude of burner pressure drops in the HVAC system; and
triggering a wind squall control process when the at least one of the frequency and the amplitude of the burner pressure drops is above a threshold value for a predetermined time period, wherein the wind squall control process comprises:
adjusting at least one of a burner pressure drop setpoint and a burner pressure drop limit by decreasing the at least one of the burner pressure drop setpoint and the burner pressure drop limit; and.
resetting the at least one of the burner pressure drop setpoint and the burner pressure drop limit to its initial value when the at least one of the frequency and the amplitude of the burner pressure drops is above the threshold value.

14. (canceled)

15. (canceled)

16. The method of claim 4, wherein the space comprises a kitchen space with at least one cooking appliance.

17. A method for controlling a variable-speed direct gas-fired air-handling unit of a HVAC system in gas communication with a kitchen space and including a supply fan blowing a make-up airflow in the space and having low and high speed limits and a burner, the method comprising the steps of:
receiving a required make-up airflow value;
calculating a supply fan speed command based on the received required make-up airflow value;
monitoring a burner status to determine if the burner is active or inactive;
if the burner is active, updating the supply fan speed command according to the high and low speed limits; and
modulating the supply fan speed according to the calculated supply fan speed command.

18. The method of claim 17, wherein modulating the supply fan speed further comprises:
determining a kitchen pressure offset; and
updating the supply fan speed command according to the kitchen pressure offset.

19. The method of claim 17, wherein the supply fan is characterized by a balancing point A characterized by a speed and a flow and a balancing point B characterized by a speed and a flow and wherein calculating the supply fan speed command comprises the steps of:
determining a kitchen pressure offset;
if the supply fan speed command is above the speed corresponding to the balancing point B and the kitchen pressure offset is positive, increasing the flow corresponding to the balancing point B;
if the supply fan speed command is above the speed corresponding to the balancing point B and the kitchen pressure offset is negative, decreasing the flow corresponding to the balancing point B;
if the supply fan speed command is not above the speed corresponding to the balancing point B and is below the speed corresponding to the balancing point A and the kitchen pressure offset is positive, increasing the flow corresponding to the balancing point A;
if the supply fan speed command is not above the speed corresponding to the balancing point B and is below the speed corresponding to the balancing point A and the kitchen pressure offset is negative, decreasing the flow corresponding to the balancing point A;
if the supply fan speed command is between the speeds corresponding to the balancing point A and the balancing point B and the kitchen pressure offset is positive, increasing the flows corresponding to the balancing point A and the balancing point B; and
if the supply fan speed command is between the speeds corresponding to the balancing point A and the balancing point B and the kitchen pressure offset is negative, increasing the flows corresponding to the balancing point A and the balancing point B.

20. (canceled)

21. (canceled)

22. The method of claim 18, further comprising:
sensing a differential pressure between the atmospheric pressure and a kitchen space;
if the differential pressure is greater than a predetermined differential pressure threshold, increasing the kitchen pressure offset;
if the differential pressure is not greater than the predetermined differential pressure threshold, decreasing the kitchen pressure offset.

23. The method of claim 17, further comprising:
sensing a pressure drop across the burner;
monitoring a burner status to determine if the burner is active or inactive; and
if the burner is active:
if the pressure drop across the burner is above a high pressure drop limit, decreasing the high speed limit of the supply fan;
if the pressure drop across the burner is below a low pressure drop limit, increasing the low speed limit of the supply fan;
if the pressure drop across the burner is between the low pressure drop limit and the high pressure drop limit and the supply fan speed command is higher or equal to the high speed limit of the supply fan, increasing the high speed limit of the supply fan;
if the pressure drop across the burner is between the low pressure drop limit and the high pressure drop limit and the supply fan speed command is lower or equal to the low speed limit of the supply fan, decreasing the low speed limit of the supply fan.

24. A method for controlling a variable-speed direct gas-fired air-handling unit of a HVAC system in gas communication with a space, the method comprising the steps of:
introducing a make-up airflow having a make-up air temperature in the space;
sensing an ambient air temperature in the space;
comparing the sensed ambient air temperature with an ambient air temperature set-point;
if the sensed ambient air temperature is above the ambient air temperature set-point, decreasing a make-up air temperature set-point;
otherwise, increasing the make-up air temperature set-point.

25. The method of claim 24, further comprising:
sensing the make-up air temperature;
comparing the sensed make-up air temperature to the make-up air temperature setpoint;
increasing a minimum make-up airflow if the sensed make-up air temperature is above the make-up air temperature setpoint;
otherwise, decreasing the minimum make-up airflow.

26. (canceled)

27. The method of claim 24, wherein the variable-speed direct gas-fired air-handling unit comprises a burner having a burner status and a burner gas valve outflow with a gas valve lower limit, bypass dampers, and a minimum make-up airflow having a higher limit and a lower limit, the method comprising the steps of:
sensing the make-up air temperature;
comparing the sensed make-up air temperature to a make-up air temperature setpoint;
if the sensed make-up air temperature is above the make-up air temperature setpoint;
monitoring the burner status to determine if the burner is active or inactive;
if the burner is inactive, increasing the minimum make-up airflow;
if the burner is active and the gas valve outflow has not reached the gas valve lower limit, performing one of decreasing the gas valve outflow and decreasing a gas valve position setpoint;
if the burner is active, the gas valve outflow has reached the gas valve lower limit and the minimum make-up airflow has not reached the minimum make-up airflow higher limit, increasing the minimum make-up airflow;
if the burner is active, the gas valve outflow has reached the gas valve lower limit and the minimum make-up airflow has reached the minimum make-up airflow higher limit, triggering a burner extinction process; and
if the make-up air temperature is not above the make-up air temperature setpoint;
decreasing the minimum make-up airflow.

28. (canceled)

29. The method of claim 27, wherein the burner extinction process comprises the steps of:
determining if the burner has been active for longer than a predetermined ON-time period;
if the burner has been active for longer than the predetermined ON-time period:
powering off the burner; and
resetting the minimum make-up airflow to the minimum make-up airflow lower limit.

30. The method of claim 27, wherein if the make-up air temperature is below the make-up air temperature setpoint, the method further comprises:
monitoring the burner status to determine if the burner is active or inactive;
if the burner is active, performing one of increasing the gas valve outflow and increasing the gas valve position setpoint; and
if the burner is inactive, triggering a burner ignition process comprising:
determining a dead band width based on a minimum increase in the make-up air temperature when the burner is active;
determining if a difference between the make-up air temperature and the make-up air temperature setpoint is above the dead band width; and
if the difference between the make-up air temperature and the make-up air temperature setpoint is above the dead band width, igniting the burner.

31. (canceled)

32. (canceled)

33. The method of claim 30, wherein the burner ignition process further comprises the steps of:
increasing at least one of a burner pressure drop setpoint and a burner pressure drop limit before igniting the burner; and
resetting the at least one of the burner pressure drop setpoint and the burner pressure drop limit after ignition of the burner.

34. The method of claim 24, further comprising:
monitoring at least one of a frequency and an amplitude of burner pressure drops in the HVAC system; and
triggering a wind squall control process when the at least one of the frequency and the amplitude of the burner pressure drops is above a threshold value for a predetermined time period, wherein the wind squall control process comprises:
adjusting at least one of a burner pressure drop setpoint and a burner pressure drop limit; and
resetting the at least one of the burner pressure drop setpoint and the burner pressure drop limit to its initial value when the at least one of the frequency and the amplitude of the burner pressure drops is above the threshold value.

35. (canceled)

36. The method of claim 24, further comprising:
sensing a pressure drop across the burner;
monitoring a burner status to determine if the burner is active or inactive; and
if the burner is active:
if the pressure drop across the burner is above a high pressure drop limit, decreasing the high speed limit of the supply fan;
if the pressure drop across the burner is below a low pressure drop limit, increasing the low speed limit of the supply fan;
if the pressure drop across the burner is between the low pressure drop limit and the high pressure drop limit and the supply fan speed command is higher or equal to the high speed limit of the supply fan, increasing the high speed limit of the supply fan;
if the pressure drop across the burner is between the low pressure drop limit and the high pressure drop limit and the supply fan speed command is lower or equal to the low speed limit of the supply fan, decreasing the low speed limit of the supply fan.
